(19) United States
(12) Patent Application Publication
(10) Pub. No.: US 2008/0002521 A1
(43) Pub. Date: Jan. 3, 2008

(54) Mixing Sheet

(76) Inventors: Taro Hosozawa, Tokyo (JP); Masaya Seto, Tokyo (JP)

Correspondence Address: GREER, BURNS & CRAIN, 300 S WACKER DR, 25TH FLOOR, CHICAGO, IL, 60606, US

(21) Appl. No.: 11/587,841

(22) PCT Filed: May 2, 2005
(86) PCT No.: PCT/JP05/08299

§ 371 Date: Oct. 26, 2006

(30) Foreign Application Priority Data
Apr. 30, 2004 (JP) 2004-135663

(51) Int. Cl. B01F 13/00

(52) U.S. Cl. 366/341

(57) ABSTRACT

A mixing sheet capable of mixing multiple types of mixed materials filled therein, simply formed, easily manufacturable, and enabling a reduction in the residual amount of the mixed materials thereon after servicing. The mixed materials are passed, for mixing, through a first mixing passage formed between first outer frame members (21) and partition members (23) and second mixing passages formed between second outer frame members (22) and the partition members (23). The first mixing passage and the second mixing passage are formed by joining the first outer frame members (21) to the partition members (23) and the second outer frame members (22) to the partition members (23). These first mixing passage and the second mixing passage comprises a plurality of elements arranged in series. Hole parts (23a) along the moving direction of the mixed materials are formed in the partition members (23), the mixed materials passed through the first and second mixing passages are repeatedly divided and merged by circulating to each other through the hole parts (23a), and the mixed materials passed through these mixing passages are mixed.

### TECHNICAL FIELD

The present invention relates to a mixing sheet, and more particularly, to a mixing sheet suitable for use in mixing together components of a multi-component reactive adhesive, such as epoxy, polyurethane, and silicone, or in mixing together a plurality of fluid materials, such as resin cement, sealant, and filling material.

### BACKGROUND ART

For example, in the case of a two-component epoxy type adhesive, a main component and a hardening agent are separately prepared, and are mixed with each other at a time of use. As a mixing tube for mixing the main component and the hardening agent with each other, the present applicant has already proposed a mixing tube for mixing a plurality of kinds of materials to be mixed that are discharged from a plurality of attached containers for separately containing a plurality of kinds of fluid materials to be mixed with each other (Patent Document 1).

This mixing tube has a tube inlet to be attached to containers containing the materials to be mixed, a mixing passage for mixing a plurality of kinds of materials to be mixed that are poured in through the inlet, and an outlet for discharging the materials that have been mixed together through the missing passage. By continuously crushing the mixing passage from the inlet side toward the discharge outlet side, the plurality of kinds of materials to be mixed that are poured in through the inlet are mixed together while passing through the mixing passage before being discharged from the outlet.

In the missing passage of this mixing tube, a plurality of passage blocks having deformed passages in the same number as the materials to be mixed are connected in series, and, through an appropriate combination of orientations of the outlets and inlets of the deformed passages at the connecting portions between passage blocks, the following action is repeated: the materials to be mixed discharged from one passage block on the input side are divided at the inlet of another passage block on the output side thereof and merged at the outlet thereof. In this mixing tube, assuming that the number of connection portions between the passage blocks is n, the materials to be mixed are divided in 2ⁿ, whereby a mixing action is generated.

However, in the above-mentioned mixing tube, a plurality of passage blocks having deformed passages are previously formed and endowed with predetermined configurations, so when squeezing out the materials to be mixed, it is impossible to squeeze out the materials to be mixed in the deformed passage portions to a sufficient degree, and there is a fear of a relatively large amount of materials to be mixed remaining inside. In particular, in the field of dental materials or the like, expensive materials are often used in small quantities, so there is a demand for a mixing tube which involves only a small residual amount of materials.

Patent Document 1: JP 2003-1078 A

### DISCLOSURE OF THE INVENTION

The present invention has been made in view of the above problem in the prior art. It is a technical object of the present invention to provide a mixing sheet which is to be filled with a plurality of kinds of materials to be mixed and in which these materials are mixed with each other, the mixing sheet being of a simple structure easy to manufacture and allowing a reduction in the residual amount of materials to be mixed after use.

To achieve the above technical object, the mixing sheet of the present invention is constructed as follows.

That is, there is provided a mixing sheet which is formed by bonding together a sheet-like first outer frame member and a sheet-like second outer frame member which are formed of film members and a sheet-like partition member existing between the first outer frame member and the second outer frame member and in which materials to be mixed are mixed together by being passed through a first mixing passage formed between the first outer frame member and the partition member and through a second mixing passage formed between the second outer frame member and the partition member, wherein each of the first mixing passage and the second mixing passage is formed by bonding the first outer frame member and the partition member to each other, and the second outer frame member and the partition member to each other, that the first mixing passage and the second mixing passage are provided with a plurality of elements arranged in series, that the partition member has hole parts respectively provided for the elements, and that the materials to be mixed that are passed through the first mixing passage and the second mixing passage are repeatedly divided and merged by circulating to each other through the hole parts, whereby the materials to be mixed that are passed through the first mixing passage and the second mixing passage are mixed with each other.

As the elements, it is desirable to adopt ones allowing division and merging of the materials to be mixed at least once at the time of passage of the materials to be mixed.

The materials to be mixed that have flowed into the first mixing passage and the second mixing passage are merged as the first mixing passage and the second mixing passage are joined in a direction perpendicular to the direction in which the separation is effected by the partition member, the merged materials to be mixed are again divided by the partition member, and the step of being merged in the direction perpendicular to the direction in which the separation is effected by the partition member may be repeated.

Further, the materials to be mixed that have flowed into the first mixing passage and the second mixing passage separated by the partition member are divided as the first mixing passage and the second mixing passage are divided in a direction perpendicular to the direction in which the separation is effected by the partition member, the divided materials to be mixed are merged in a direction perpendicular to the direction in which the division is effected, the merged materials to be mixed are again separated by the partition member, and the step of being divided in the direction perpendicular to the direction in which the separation is effected by the partition member may be repeated.

According to the present invention, the first mixing passage and the second mixing massage repeat division and merging, so the materials to be mixed passing therethrough also repeat division and merging. Thus, the materials to be mixed are mixed together to a sufficient degree. Further, this mixing sheet is formed by bonding together a first outer frame member, a second outer frame member, and a partition member formed of film members, and hollow portions formed by these members constitute the first mixing passage and the second mixing passage. Thus, by not bonding portions that are to constitute the first mixing passage and the second mixing passage to each other, those mixing passages can be formed.

When the materials to be mixed are poured in, the first mixing passage and the second mixing passage are swollen, and are shaped into passages. That is, the first mixing passage and the second mixing passage are shaped through the pouring-in of the materials to be mixed, and, in a state prior to use, the mixing sheet as a whole assumes a completely sheet-like form.

Thus, when squeezing out the materials to be mixed, the materials to be mixed in the first mixing passage and the second mixing passage can be squeezed out easily and to a sufficient degree, so it is possible to reduce amount of materials to be mixed remaining inside. Further, as compared with the conventional mixing tubes, a simplification in structure is achieved, and the manufacture thereof is facilitated, so a mass production of mixing tubes, which has been rather difficult to perform, can be easily conducted.

The film members are formed of thin and flexible film-like members; for example, they may be formed of a thermoplastic resin. A thermoplastic resin is softened and melted when heated, and is hardened when cooled, so it allows bonding through thermal fusion-bonding, high-frequency fusion-bonding, ultrasonic fusion-bonding, etc. Examples of the thermoplastic resin that can be used include resins, such as a styrene type resin, an acrylic type resin, a cellulose type resin, a polyethylene type resin, a vinyl type resin, a nylon type resin, a fluorocarbon type resin, a polypropylene type resin, and a polyester type resin, and a (multi-layered) laminate film.

When using the mixing sheet, the materials to be mixed can be mixed together and squeezed out through crushing with fingers, a jig or the like. Thus, as the material of the mixing sheet, a flexible material that can be crushed with a predetermined force is preferable. In this mixing sheet, the first mixing passage and the second mixing passage are continuously crushed from the inlet side toward the outlet side, whereby the materials to be mixed therein are caused to pass through the mixing passages, making it possible to mix them with each other to a sufficient degree. Further, by completely crushing the mixing passages to forward ends of the outlets thereof, it is possible to substantially completely squeeze out the materials to be mixed therein.

As described above, different kinds of materials to be mixed having flowed into the first mixing passage and the second mixing passage are squeezed out toward the outlet of the mixing sheet to be thereby repeatedly divided and merged and are mixed together while forming 2ⁿ layers.

Further, the first missing passage and the second missing passage of the mixing sheet of the present invention are shaped through the pouring-in of the materials to be mixed. As stated above, the first mixing passage and the second mixing passage are formed of hollow portions formed between the first outer frame member, the second outer frame member, and the partition member; however, there is no need to previously shape them into a predetermined configuration; they can be formed by not bonding together the portions that are to constitute the mixing passages. Generally speaking, the film members are in a sheet-like form, and an outward appearance of the mixing sheet formed by bonding together the above-mentioned members is a sheet-like form. Thus, prior to the pouring-in of the materials to be mixed, the hollow portions that are to constitute the first missing passage and the second missing passage are not swollen; when the materials to be mixed are poured in, the portions corresponding to the mixing passages are swollen, and their contour becomes apparent. When using the mixing sheet, the mixing passages shaped through the pouring-in of the materials to be mixed are crushed, whereby the materials to be mixed can be mixed together and squeezed out. After the materials to be mixed have been squeezed out, the mixing sheet is restored to the sheet-like form.

### EFFECTS OF THE INVENTION

In the mixing sheet of the present invention, the first mixing passage and the second mixing passage are continuously crushed, and the materials to be mixed are squeezed out, whereby it is possible to generate a mixing action.

According to the present invention, by passing the materials to be mixed through the elements whose sectional configurations are changed continuously, it is possible to intermittently mix together the materials to be mixed. Further, in the partition member, there are provided hole parts respectively for the elements, so the materials to be mixed passing through the deformed passages regularly repeat division and merging. As a result, it is possible to uniformly mix a plurality of materials to be mixed. Further, it is also possible to adopt an arrangement in which the first mixing passage and the second mixing passage undergo division and merging at the respective connecting portions of the elements so that the following action is repeated: the materials to be mixed discharged from one element are divided at the inlet of the subsequent element and merged at the outlet thereof. With this construction, assuming that the number of elements connected together is n, it is possible to divide and merge the materials to be mixed in 2ⁿ.

As described above, in the present invention, the materials to be mixed filling the sheet are caused to continuously undergo division and merging, making it possible to mix them with each other. Further, since the mixing sheet is formed by bonding the film members to each other, it is possible to substantially completely squeeze out the materials to be mixed, making it possible to reduce the residual amount of materials after use. Further, in the state in which the films are bonded together, the whole is in a form of a thin sheet, which is convenient from the viewpoint of transport, carrying, and disposal.

### BRIEF DESCRIPTION OF THE DRAWINGS

FIG. 1 is a plan view of a mixing sheet according to the present invention.

FIG. 2 is an exploded plan view of the mixing sheet as divided into a first film member, a second film member, and a partition member.

FIG. 3 is a perspective view showing a first passage block and a second passage block of the mixing sheet.

FIG. 4 is a diagram showing how mixing is effected in the first passage block of the mixing sheet.

FIG. 5 is an exploded plan view of a mixing sheet according to another embodiment as divided into a first film member, a second film member, and a partition member.

FIG. 6 is a perspective view showing a first passage block and a second passage block of the mixing sheet according to the other embodiment.

FIG. 7 is a perspective view of a first passage block and a second passage block of the mixing sheet of FIG. 3, illustrating an example in which the materials to be mixed are passed through the mixing sheet in an opposite direction.

FIG. 8 is a diagram illustrating how mixing is effected in the second passage block in the example in which, in the mixing sheet of FIG. 3, the materials to be mixed are passed in the opposite direction.

### DESCRIPTION OF SYMBOLS

10, 30 mixing sheet

11 first passage block

12 second passage block

21 first film member

22 second film member

23, 25 partition member

### BEST MODE FOR CARRYING OUT THE INVENTION

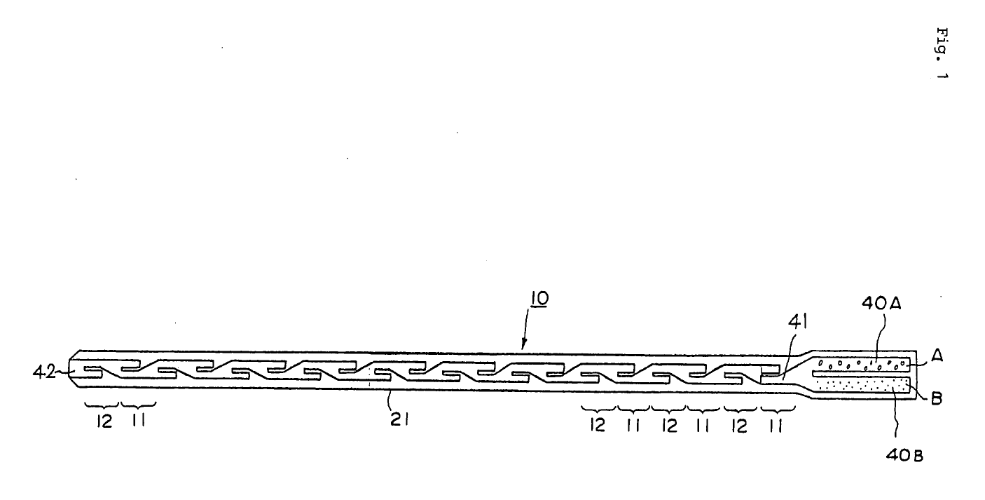

Next, a mixing sheet according to an embodiment of the present invention will be described in detail with reference to the drawings. FIG. 1 is a plan view of a mixing sheet 10 according to this embodiment. The mixing sheet 10 has accommodating portions 40A, 40B separately accommodating two kinds of fluid materials to be mixed A, B, and a mixing passage communicating with the accommodating portions and allowing passage of the materials to be mixed therethrough to mix the materials to be mixed with each other.

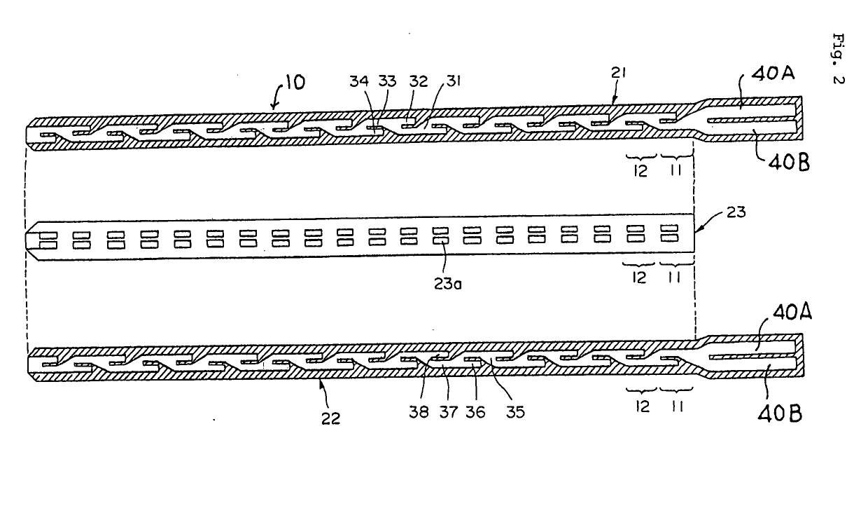

The mixing sheet 10 is formed by bonding together three flat films of a soft thermoplastic resin that can be crushed as a whole with a predetermined force. FIG. 2 is an exploded view of the mixing sheet. The three flat films are formed of a first film member 21 as a first outer frame member, a second film member 22 as a second outer frame member, and a partition member 23 provided therebetween. At the longitudinal ends and at the center of the mixing sheet, fusion-bonding is partially effected between the first film member 21 and the partition member 23, and between the second film member 22 and the partition member 23, with portions not fusion-bonded to each other constituting mixing passages for the materials to be mixed. The fusion-bonding is effected on shaded portions of FIG. 2. In the state in which no materials to be mixed is poured in, the mixing passages are not shaped, and the mixing sheet remains in a sheet-like form.

When the materials to be mixed are poured in, the space portions between the members are swollen by the materials to be mixed, and the mixing passages are shaped. When mixing the materials to be mixed, the mixing sheet 10 is continuously crushed from an inlet 41 toward an outlet 42 thereof, whereby the materials to be mixed are passed through the mixing passages.

By crushing the mixing sheet to the outlet 42 as described above, it is possible to squeeze out the materials mixed to a sufficient degree from the outlet 42; after the squeezing-out, the mixing sheet is restored to the sheet-like form.

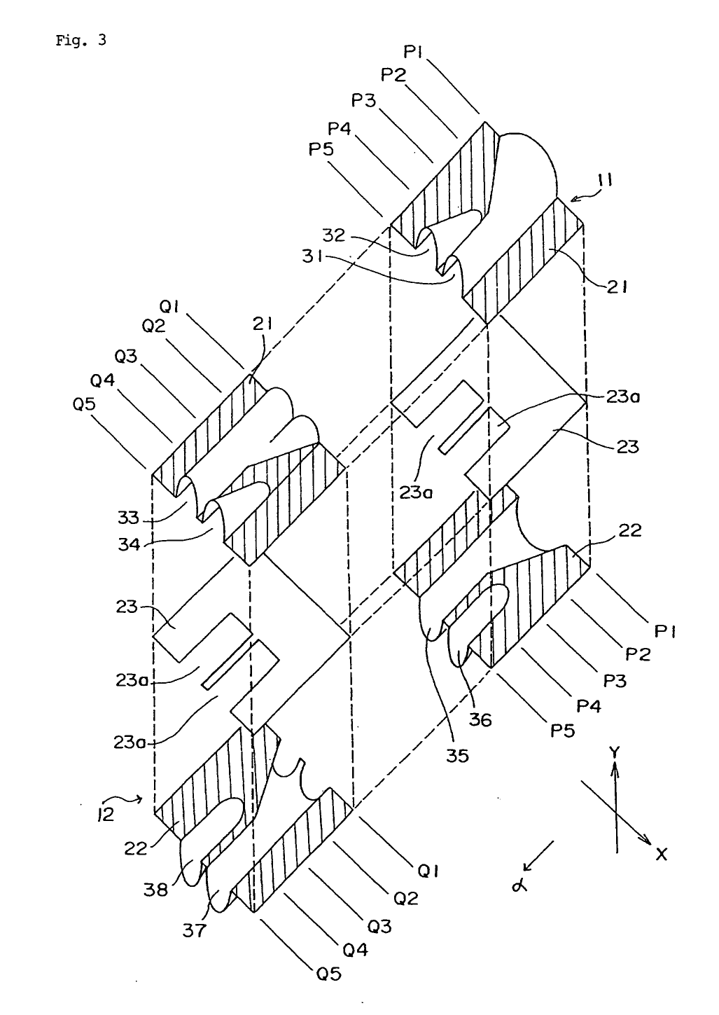

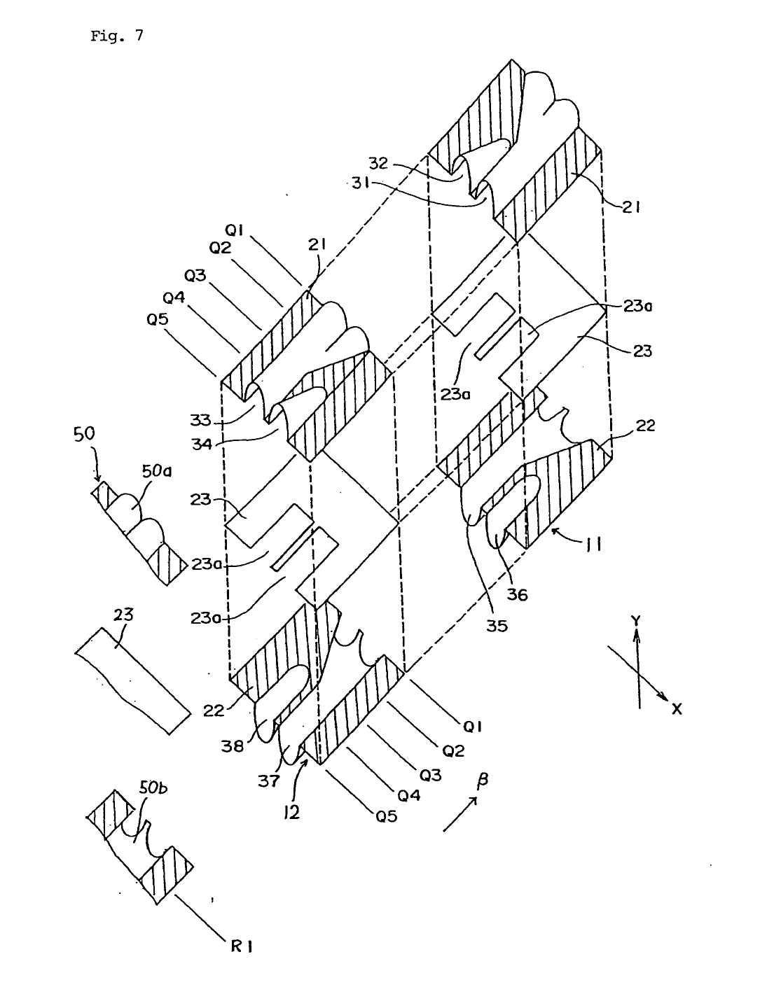

The mixing passages will be described in detail with reference to FIGS. 1 through 8. FIGS. 3 and 7 are exploded perspective views showing the inlet portion of the mixing sheet 10 in the state in which the materials to be mixed are poured in. FIG. 3 shows a case in which the materials to be mixed are poured in from a first passage block 11 side, and FIG. 7 shows a case in which the materials to be mixed are poured in from a second passage block 12 side. In these figures, the mixing sheet is shown with the materials to be mixed omitted.

As shown in FIGS. 1 and 2, in the mixing sheet 10, two kinds of passage blocks: first passage blocks 11 and second passage blocks 12, are connected together in a plurality of pairs; formed in each pair of the passage blocks 11, 12 are first through eighth deformed passages 31 through 38 for mixing. Each of the passage blocks 11 or 12 corresponds to each element.

Hole parts 23a are formed in the partition member 23. The first through fourth deformed passages 31 through 34 formed between the first film member 21 and the partition member 23 and the fifth through eighth deformed passages 35 through 38 formed between the second film member 22 and the partition member 23 allow division and merging through the hole parts 23a of the partition member 23.

Each of the first deformed passage 31 and the fifth deformed passage 35 of the first passage block 11 has a semi-circular inlet elongated in an X-axis direction, with the sectional configuration thereof being changed continuously from an inlet point P1 toward a midpoint P3. From the midpoint P3 to an outlet point P5, there are formed the second deformed passage 32 and the sixth deformed passage 36 in parallel with the first deformed passage 31 and the fifth deformed passage 35, which means there are formed four deformed passages in total.

From the midpoint P3 to the point P5, two hole parts 23a are provided side by side in the partition member 23 so as to respectively establish communication between the first deformed passage 31 and the sixth deformed passage 36, and between the second deformed passage 32 and the fifth deformed passage 35. As stated above, in forming these deformed passages, no fusion-bonding is effected on the portions that are to constitute these deformed passages, and fusion-bonding is only effected on the periphery thereof.

Like the first passage block 11, the second passage block 12 has four deformed passages, which are arranged so as to be reverse to the deformed passages of the first passage block 11 in the X-axis direction. At a connecting portion (P1, Q1) between the first passage block 11 and the second passage block 12, the first deformed passage 31 and the second deformed passage 32 of the first passage block 11 on an upstream side communicate with the third deformed passage 33 of the second passage block 12 on a downstream side, and the fifth deformed passage 35 and the sixth deformed passage 36 of the first passage block 11 communicate with the seventh deformed passage 37 of the second passage block 12. In this way, each deformed passage repeats division and merging, so the materials to be mixed that are passed therethrough also undergo division and merging, making it possible to mix them with each other.

The mixing action by the mixing sheet shown in FIG. 3 will be described in terms of a Y-axis direction and the X-axis direction. The materials to be mixed move in the direction indicated by an arrow a, and are first divided in the Y-axis direction by the partition member 23. Next, the materials to be mixed having flowed into the first through fourth deformed passages 31 through 34 formed between the first film member 21 and the partition member 23, and into the fifth through eighth deformed passages 35 through 38 formed between the second film member 22 and the partition member 23 undergo merging as the first through fourth deformed passages 31 through 34 and the fifth through eighth deformed passages 35 through 38 are joined in the X-axis direction, which is orthogonal to the Y-axis direction. The merged materials to be mixed are again divided in the Y-axis direction by the partition member 23 and repeat the step of being merged in the X-axis direction.

A description in more detail will be given of how the materials to be mixed A, B are mixed together as they pass through the first passage block 11 and the second passage block 12.

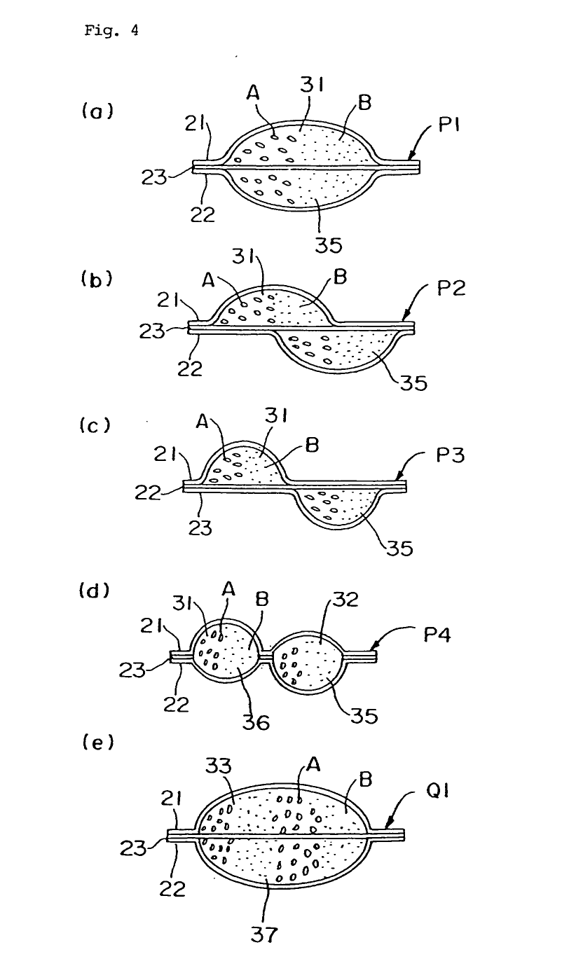

FIGS. 4(a) through 4(e) show how the materials to be mixed move in the direction of the arrow a of FIG. 3, and pass through the first passage block 11. Reference symbols P1 through P4 and Q1 of FIG. 4 correspond to material positions in the first block 11 and the second block 12 of FIG. 3.

The materials to be mixed A, B poured into the first passage block 11 from the accommodating portions 40A, 40B are divided into the first deformed passage 31 and the fifth deformed passage 35 at the inlet point P1 (a). Then, a length in the horizontal direction (X-axis direction) of the passages is gradually diminished (b); at the midpoint P3, the width of the first deformed passage 31 and the fifth deformed passage 35 is reduced to substantially ½ (c). After this, communication is provided between the first deformed passage 31 and the sixth deformed passage 36 and between the second deformed passage 32 and the fifth deformed passage 35 through the hole parts 23a of the partition member 23 (d). Then, the materials to be mixed A, B mixed together through the communication between the first deformed passage 31 and the sixth deformed passage 36 of the first passage block 11 are divided into the third deformed passage 33 and the seventh deformed passage 37 at the inlet point Q1 of the second passage block 12. Ina similar manner, the materials to be mixed A, B mixed together through the communication between the second deformed passage 32 and the fifth deformed passage 35 of the first passage block 11 are also divided into the third deformed passage 33 and the seventh deformed passage 37 at the inlet point Q1 of the second passage block 12 (e).

While in this example the respective widths of the deformed passages are changed gradually, this should not be construed restrictively; the widths of the deformed passages may also be changed at a predetermined position when the materials to be mixed are divided and merged as the passages communicate with each other through the hole parts 23a.

In the above example, it is not absolutely necessary for the respective widths of the first deformed passage 31 and the fifth deformed passage 35 to be continuously changed from the inlet point P1 toward the midpoint P3; it is only necessary to adopt a structure in which the materials to be mixed that have been divided move simply in the horizontal direction (X-axis direction).

Further, it is not absolutely necessary for the change in the widths of the deformed passages to be ½ (two times) . Actually, the materials to be mixed do not always move while completely filling the interior of the deformed passages; since the distribution of the materials to be fixed is not uniform, it is not absolutely necessary to strictly design the change in the widths of the deformed passages.

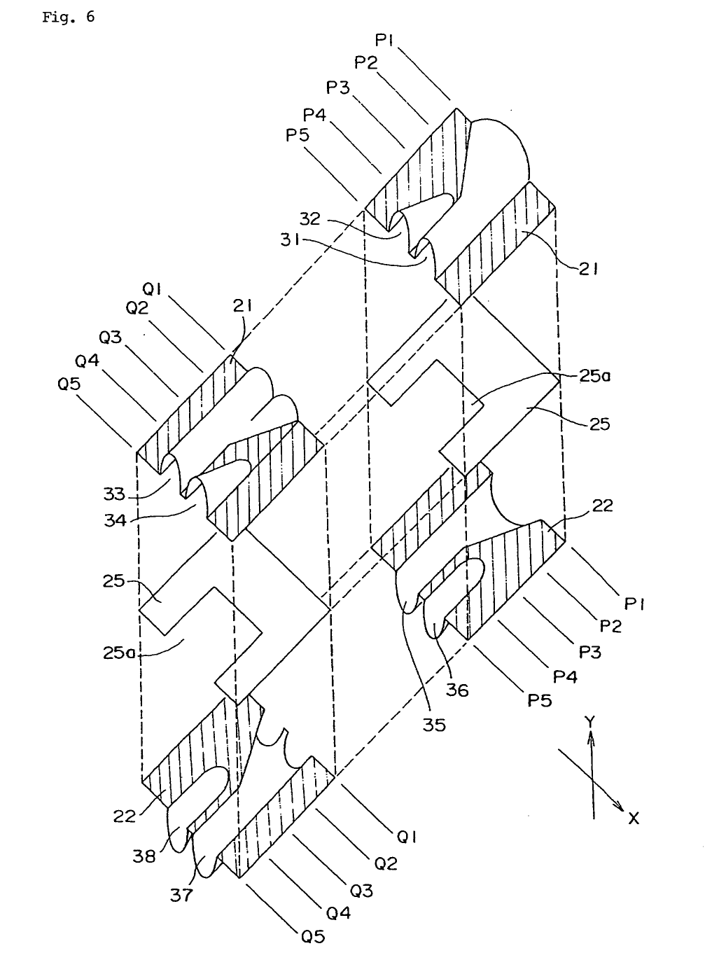

Next, the mixing action of the mixing sheet shown in FIG. 6 will be described in terms of the Y-axis direction and the X-axis direction. While this mixing sheet is of a construction similar to that shown in FIG. 3, the materials to be mixed move in the opposite direction (direction of an arrow β of FIG. 6), and the division and merging of the materials to be mixed are effected in a direction differing from that shown in FIG. 4 by 90°.

An accommodating portion 50 is separated in the Y-axis direction by the partition member 23; a first chamber 50a is filled with the material to be mixed A, and a second chamber 50b is filled with the material to be mixed B. The materials to be mixed A, B flowing in from the accommodating portion 50 enter the first through fourth deformed passages 31 through 34 formed between the first film member 21 and the partition member 23, and the fifth through eighth deformed passages 35 through 38 formed between the second film member 22 and the partition member 23. In this process, the materials to be mixed A, b are divided in the X-axis direction perpendicular to the Y-axis direction as the passage is divided into the third deformed passage 33 and the fourth deformed passage 34 and into the eighth deformed passage 38 and the seventh deformed passage 37. The divided materials to be mixed A, B are again separated in the Y-axis direction by the partition member 23, and repeat the step of being divided in the X-axis direction, which is perpendicular to the separating direction.

The way the mixing is effected as the materials to be mixed A, B pass through the first passage block 11 and the second passage block 12 will be described in more detail.

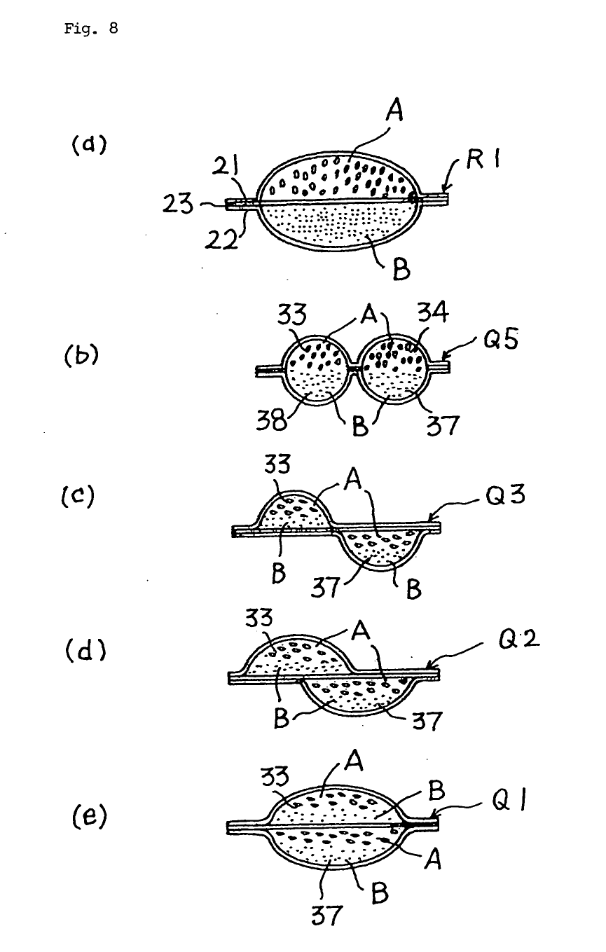

FIGS. 8(a) through 8(e) show how the materials to be mixed move in the mixing sheet of FIG. 7 in the direction of the arrow of FIG. 7, passing through the second passage block 12. Reference symbols Q1 through Q5 and R1 of FIGS. 8(a) through 8(e) correspond to the material positions in the accommodating portion 50 and the second passage block 12 of FIG. 7.

In the accommodating portion 50, division is effected by the partition member 23 such that the material to be mixed A is on an upper side and that the material to be mixed B is on a lower side. In this state, the materials to be mixed A, B do not come into contact with each other (a). The materials to be mixed A, B which have flowed into the second passage block 12 from the accommodating portion 50 are divided in the horizontal direction (X-axis direction) as the passage is divided at the inlet point Q5 in the horizontal direction (X-axis direction) into the third deformed passage 33 and the fourth deformed passage 34 and into the eighth deformed passage 38 and the seventh deformed passage 37 (b). Then, the passage length in the Y-axis direction increases gradually; at the midpoint Q3, the third deformed passage 33 and the eighth deformed passage 38 are transformed into the third deformed passage 33 on the upper side, and the fourth deformed passage 34 and the seventh deformed passage 37 are transformed into the seventh passage 37 on the lower side (c). Then, the passage length in the X-direction increases gradually (d), and, at the outlet point Q1, the third passage 33 and the seventh passage 37 are separated vertically from each other by the partition member 23.

In this way, the two kinds of materials to be mixed A, B are mixed with each other through substantial merging and dividing actions. That is, in the mixing sheet 10 of the present invention, based on a 2ⁿ theory, the materials to be mixed A, B repeat division and merging to form layers of the materials to be mixed A, B, so the larger the number of stages of the first passage block 11 and the second passage block 12, the higher the mixing degree.

Next, a method of manufacturing the mixing sheet 10 will be described.

First, the hole parts 23a are formed in the partition member 23, and the partition member 23 is held between the first film member 21 and the second film member 22. Then, the film members 21, 22 and the partition member 23 are fusion-bonded to each other. The positions where the fusion-bonding is effected are other than the portions where the deformed passages 31 through 38 are to be formed. As stated above, the first mixing passage and the second mixing passage differ in their arrangement positions, so even in the state in which the film members are superimposed one upon the other, the first through fourth deformed passages 31 through 34 formed between the first film member 21 and the partition member 23 and the fifth through eighth deformed passages 35 through 38 formed between the second film member 22 and the partition member 23 are not superimposed one upon the other. Thus, here, there are portions where three film members are to be fusion-bonded to each other, and portions where only two film members are to be fusion-bonded to each other. Regarding the portions where only two film members are to be fusion-bonded to each other, some contrivance is needed to prevent fusion-bonding of three film members. For example, it is possible to perform fusion-bonding solely on two film members by making the partition member thicker than the film members, or producing a difference in flexibility between the partition member and the film members and using a harder material for the film members.

As a means for fusion-bonding only two of the three film members and partially forming portions where no fusion-bonding is effected, methods are available according to which the physical properties of the fusion-bonding surfaces are made different. For example, different kinds of plastic materials are used, or a surface modification processing, such as a printing processing or a corona processing, is performed. Further, it may be possible to form the fusion-bonding surfaces of the three film members of different plastic materials (e.g., polypropylene and polyethylene), and place a laminate film formed of a polypropylene sheet and a polyethylene sheet bonded together between the surfaces to be fusion-bonded to each other, thereby making it possible to effect fusion-bonding. In this case, at the fusion-bonded portions, five films in total are superimposed one upon the other.

In any case, the mixing sheet 10 of this embodiment can be produced by appropriately bonding thin film members to each other, so it helps to attain a substantial improvement in terms of production efficiency as compared with the conventional mixing sheets.

Next, a mixing sheet 30 according to another embodiment, in which the partition member differs, will be described.

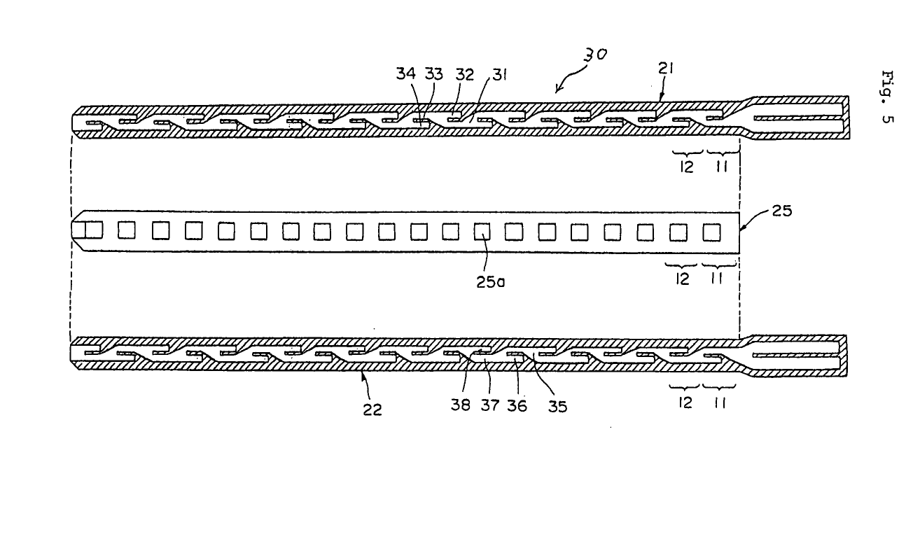

FIG. 5 is an exploded plan view of the mixing sheet 30, and FIG. 6 is a perspective view of passage blocks of the mixing sheet 30.

Two hole parts 23a are provided in the partition member 23 of the mixing sheet 10 of the above-mentioned embodiment. In contrast, a partition member 25 of the mixing sheet 30 of the other embodiment is equipped with one hole part 25a.

Thus, when the three members are superimposed one upon the other, the first film member 21 and the second film member 22 come into contact with each other through the hole part 25a of the partition member 25, and the first film member and the second film member are fusion-bonded to each other. If the hole part 25a of the partition member 25 is thus provided in an integral fashion, by fusion-bonding the first film member 21 and the second film member 22 to each other at a central portion thereof, a structure of the mixing passages of the completed mixing sheet 30 is the same as that of the above-mentioned mixing sheet 10.

Apart from the structure of the partition member 25, the mixing sheet 30 is the same as the above-mentioned mixing sheet 10, so the same components are indicated by the same reference symbols and a description thereof will be omitted.

### INDUSTRIAL APPLICABILITY

The present invention provides a mixing sheet which can be used to mix a plurality of materials to be mixed and which easily allows mixing of components of a two-component reactive adhesive, such as epoxy, polyurethane, and silicone, or mixing of resin cement, sealant, filling material, etc. Further, since the mixing sheet involves only a small residual amount of materials to be mixed, and is superior in portability, transportation property, etc., it can be used for the mixing of various materials.

1. A mixing sheet which is formed by bonding together a sheet-like first outer frame member and a sheet-like second outer frame member which are formed of film members and a sheet-like partition member existing between the first outer frame member and the second outer frame member and in which materials to be mixed are mixed together by being passed through a first mixing passage formed between the first outer frame member and the partition member and through a second mixing passage formed between the second outer frame member and the partition member,
wherein each of the first mixing passage and the second mixing passage is formed by bonding the first outer frame member and the partition member to each other, and the second outer frame member and the partition member to each other, that the first mixing passage and the second missing passage are provided with a plurality of elements arranged in series, that the partition member has hole parts respectively provided for the elements, and that the materials to be mixed that are passed through the first mixing passage and the second mixing passage are repeatedly divided and merged by circulating to each other through the hole parts, whereby the materials to be mixed that are passed through the first missing passage and the second mixing passage are mixed with each other.

2. The mixing sheet according to claim 1, wherein the first mixing passage and the second mixing passage are swollen when the materials to be mixed are poured in the first mixing passage and the second mixing passage, and are shaped into passages.

3. The mixing sheet according to claim 1 or 2, wherein different kinds of materials to be mixed having flowed into the first mixing passage and the second mixing passage are squeezed out toward an outlet of the mixing sheet to be repeatedly divided and merged and are mixed together while forming 2ⁿ layers.

4. The mixing sheet according to any one of claims 1 through 3, wherein the materials to be mixed that have flowed into the first mixing passage and the second mixing passage while being divided in a direction in which the separation is effected by the partition member, are merged as the first mixing passage and the second mixing passage are joined in a direction perpendicular to the direction in which the separation is effected by the partition member, and that the merged materials to be mixed are again divided by the partition member to repeat the step of being merged in the direction perpendicular to the direction in which the separation is effected by the partition member.

5. The mixing sheet according to any one of claims 1 through 3, wherein the materials to be mixed that have flowed into the first mixing passage and the second mixing passage separated by the partition member are divided as the first mixing passage and the second mixing passage are divided in a direction perpendicular to the direction in which the separation is effected by the partition member, that the divided materials to be mixed are merged in a direction perpendicular to the direction in which the division is effected, and that the merged materials to be mixed are again separated by the partition member to repeat the step of being divided in the direction perpendicular to the direction in which the separation is effected by the partition member.

6. The mixing sheet according to any one of claims 1 through 5, wherein the first mixing passage and the second mixing passage are continuously crushed to squeeze out the materials to be mixed to generate a mixing action.
